(19) United States
(12) Patent Application Publication
(10) Pub. No.: US 2018/0239311 A1
(43) Pub. Date: Aug. 23, 2018

(54) Method and Apparatus for Controlling an Environment Management System within a Building

(71) Applicant: Energy Technologies Institute LLP, Loughborough, Leicestershire (GB)

(72) Inventors: Andrew Michael HASLETT, Heswall (GB); Matthew Michael LIPSON, Warwick (GB)

(73) Assignee: Energy Technologies Institute LLP, Loughborough, Leicestershire (GB)

(21) Appl. No.: 15/552,817

(22) PCT Filed: Feb. 24, 2016
(86) PCT No.: PCT/GB2016/050461

§ 371 Date: Aug. 23, 2017

(30) Foreign Application Priority Data
Feb. 24, 2015 (GB) 1503047.1

(51) Int. Cl. G05B 13/02; H04L 12/28

(52) U.S. Cl. CPC G05B 13/028; H04L 12/2823; G05B 13/026

(57) ABSTRACT

A method of controlling an environment management system within a building, comprises: monitoring appliance usage within the building; determining patterns of appliance usage that are characteristic of an occupant; creating and storing a persona comprising the patterns of appliance usage; identifying an expected pattern of appliance usage associated with the occupant based on a comparison of detected appliance usage with the occupant's stored persona; and operating the environment management system to control the environment in the building, in accordance with the persona.

### TECHNICAL FIELD

The present invention relates to a method and apparatus for controlling an environment management system within a building.

### BACKGROUND TO THE INVENTION

Much of the literature about energy and environment management focuses on energy consumption and use, on device efficiency and on simplistic models of people as automatons, where they have a daily programme which is known in advance, and comfort parameters described by the setting of a single thermostat in their dwelling. This could be seen as an attempt to characterise people as components of an engineering system in a way that makes meeting their needs a tightly specified challenge seen through the lens of energy consumption rather than the purpose of the activity.

Other parts of the literature describe energy use in terms of motivation and behavioural change. This could be seen as an attempt to represent them as members of society in a way that makes modifying their behaviour a target of public energy policy. While neither of these is wrong per se, they fail to capture the richness of human behaviour and needs and especially the way that well designed Building Environment Management Systems (BEMS)—in particular, Home Environment Management Systems (HEMS)—can better meet their needs.

The present invention has therefore been designed with the foregoing in mind.

For the sake of brevity, the specification tends to refer to a HEMS only. It should be understood that the invention can be applied to any BEMS, not just a HEMS.

### SUMMARY OF THE INVENTION

According to a first aspect of the present invention there is defined a method of operating an environment management system within a building as defined in claim 1. The method comprises: monitoring appliance usage within the building; determining patterns of appliance usage that are characteristic of an occupant; creating and storing a persona of the occupant comprising the patterns of appliance usage by the occupant; identifying an expected pattern of appliance usage associated with the occupant based on a comparison of detected appliance usage with the occupant's stored persona; and operating the environment management system to control the environment in the building in accordance with the persona.

Embodiments of the invention therefore enable patterns of appliance usage (i.e. occupant activity data) to be used to influence a HEMS. This is a novel approach to capturing and using information about people's activities (e.g. that use energy and water), in a way that delivers better outcomes for that person. The outcomes could comprise comfort levels (e.g. relating to heating or ventilation), budget management or interaction style.

In the context of the present invention, the term persona is used to denote a set of characteristics or behaviour patterns that are typical of an individual occupant of a building. A persona may be considered to be a user profile.

The persona may comprise behavioural data (e.g. relating to domestic activities), needs descriptions (e.g. whether the key drivers behind a person's activities are based on relationships, comfort, hygiene, resources or stability) and interaction styles (e.g. whether they prefer menus, charts, numbers, text or prompts from a control system).

The HEMS will continually learn about the subtleties of occupant behaviour through continued monitoring and review and comparison of activity patterns (or personas) with those of others. As more data is gathered, the likelihood is that more patterns of appliance usage will be identified and this can be used to change or improve the typical characteristics stored in the occupant's persona. Furthermore, the personas themselves can be developed by correlating further factors relating to human behaviour as more data is collected (i.e. relating to their needs or interaction styles).

By comparing personas it will be possible to group those that have similar characteristics into clusters and to draw inferences about the likely behaviour of an occupant based on the typical behaviour patterns of others within the same cluster. For example, people that wash their hands frequently may also tend to shower more often than others. These characteristics could therefore form the basis for a particular cluster of personas and that may infer further details about their needs and/or interaction style. Another persona cluster could be based on a group including people who tend to tightly control the temperature of their house and it may be determined that people belonging to this cluster have a high need for planning and scheduling their energy usage.

If the characteristics of large numbers of people (and their personas) are represented in multi-dimensional phase space, then clusters of related characteristics can be identified and people assigned to these clusters, based on the significant dimensions of difference. These dimensions may be described as drivers of the behaviours and may comprise relationships, comfort, hygiene, resources, stability and others. The current drivers are based on factors identified through consumer research but once a central server has information from a population of hundreds of thousands of HEMS, the drivers and clustering will be a matter of multi-dimensional analysis.

The applicants anticipate that the central server will be able to identify a large number of clusters in the UK population. Some clusters will have hundreds of thousands of members and others only a few thousand. Probably there will be a few hundred clusters with membership of over a hundred thousand, accounting for somewhere between two thirds and three quarters of the population. Until there are a large number of installed HEMS, there will be insufficient statistical power to discriminate between closely related clusters.

The step of monitoring appliance usage within the building may comprise measuring at least one property associated with a utility to determine utility usage and identifying a pattern of use of one or more appliances that is expected to give rise to such utility usage. The method may comprise comparing recent data with historical data and/or comparing data collected from a plurality of buildings. The method may comprise the use of probabilities associated with the likelihood of a pattern of appliance usage occurring at a particular time (i.e. of day, week, month, year) or in a particular sequence with one or more other patterns of appliance usage. The method may comprise comparing the most probable patterns of appliance usage with the measured data first. This helps to reduce the computation size and complexity and may speed up the process for obtaining a good match between the measured data and a hypothesised pattern of appliance usage.

The step of monitoring appliance usage within the building may be performed in any suitable way but in particular embodiments this may be in accordance with the invention described in the applicant's co-pending patent application (our ref: PB148162 GB), which is incorporated herein by reference. In which case, the step of monitoring appliance usage within the building may comprise monitoring two or more utilities and measuring one or more characteristics relating to each of the utilities to provide an output signal representative thereof; monitoring for changes in the state of each of the output signals at predefined time intervals; and combining data from the output signals from each utility, to identify one or more patterns of appliance usage. As explained in this co-pending application, statistics on patterns of behaviour can help to identify appliances. For example, a motor in operation at various times scattered between 1 am and 6 am is unlikely to be a vacuum cleaner. However the pattern of turning the heating on, making a cup of tea and switching on the television may be quite likely to occur during the night in the case of an insomniac (and some insomniacs may actually use a vacuum cleaner during the night). A newly installed HEMS could match the typical activity patterns of the occupant against others and therefore increase the a posteriori probability that the appliance is a vacuum cleaner by (probably) two orders of magnitude.

The step of determining patterns of appliance usage that are characteristic of an occupant may comprise identifying an occupant of a building and determining a pattern of behaviour associated with that occupant. The step of identifying an occupant may comprise one or more of: user input; reference to an occupant schedule; recognition of a wireless signature associated with the occupant (i.e. via a mobile device); or recognition of a particular pattern of behaviour associated with the occupant.

In order to determine a pattern of behaviour associated with that occupant, the method may comprise a learning period whereby the system monitors appliance usage for a period of time in order to identify recurring patterns of appliance usage.

The persona may further comprise user data which may be obtained by user input and/or information gained from user interactions with the system.

The step of operating the environment management system, in accordance with the persona, may comprise one or more of: i) reviewing the occupant's preferences and scheduling/rescheduling a heating/hot water program to take such preferences into account; ii) adapting a user interface for the environment management system; and iii) comparing recent patterns of appliance usage with historic patterns of appliance usage to predict occupant needs over a period of time (e.g. a few hours to a few days). The preferences may comprise scheduling criteria, budgeting criteria or room priorities.

Within each persona, the patterns of appliance usage (“work flows”) that are characteristic of each occupant are expected to have forward predictive value that will enable the HEMS to meet needs better, especially for services like heating and hot water that may have different costs at different times and which take advanced notice to deliver.

The environment management system may therefore use the persona to predict future environment requirements and may adapt to meet said requirements.

The environment management system may be operated to minimise dissatisfaction by the occupant. This may be the overriding purpose of a HEMS comprising the invention.

The persona may comprise information relating to a personality type.

The persona may include a preferred interaction style by which the occupant prefers to interact with the HEMS and/or appliances.

The step of creating a persona and/or clustering personas may comprise statistical analysis.

The method may comprise a comparison of the patterns of appliance usage of the occupant with patterns of appliance usage determined for other occupants of the same or other buildings.

When two or more occupants are identified within a building, the HEMS may attempt to ascribe the patterns of appliance usage to individual occupants, either as their own actions or as a share of activities required to meet shared needs. The shared needs may comprise laundry, housekeeping, security, comfort (i.e. heating) etc.

When two or more occupants are identified within a building their individual personas may be compared and the environment management system controlled to minimise dissatisfaction by each occupant.

The step of identifying a pattern of appliance usage associated with the individual occupant may comprise identifying when the individual occupant is out of the building and is next likely to return to the building.

The environment management system may comprise a user interface configured to adapt to a user's preferred style of interaction. This may (initially) be derived from the occupant's persona (e.g. based on activity patterns, needs/priorities, control style (i.e. delegator or manager) or personality) but may also be learnt by the system through the occupant's interaction with local control systems (e.g. thermostats, thermostatic radiator valves (TRVs)) and/or the HEMS control system itself (e.g. by adoption/selection or configuration of the controls). The style of interaction may, for example, be chart-driven, number-driven, menu-driven, text-driven or prompt-driven. In any case, it will be understood that the system applies a systematic analysis of data to adapt the user interface.

The persona for each occupant may be portable such that it can be used by the occupant when they are in another building (e.g. on holiday or after a re-location). Consequently, the personas may be considered to be portable energy use personas.

In embodiments, the identities of individuals associated with a particular persona or cluster are protected. This is because the details of personas and clusters are likely to be highly sensitive. For example, the clustering should be done in a way that protects the identities of individuals and treats the parameters of the clusters as mathematical descriptions, rather than value judgements. The clustering will be of great academic and political interest and identifying the persona of a named individual will probably be commercially valuable. The central server should not be capable of identifying the personas of individuals and individuals should be assisted to give access to parts of their personas to third parties only where they understand the implications and only in return for something they value.

The archetypical personas of clusters will be a very powerful marketing tool, not only will a product, service or policy developer understand the pattern of consumer needs and have some evidence of willingness to pay, they will also have initial guidance on how to communicate the value proposition. This could be very beneficial to consumers, but they will need to be assured that their interests are protected by the system design.

In accordance with a second aspect of the invention there is provided an apparatus for operating an environment management system within a building, comprising as defined in claim 26. The apparatus comprises: apparatus for monitoring appliance usage within the building; and a processing device configured: to determine patterns of appliance usage that are characteristic of an occupant; to create and store a persona of the occupant comprising the patterns of appliance usage by the occupant; to identify an expected pattern of appliance usage associated with the occupant based on a comparison of detected appliance usage with the occupant's stored persona; and to operate the environment management system to control the environment in the building in accordance with the persona.

In accordance with a third aspect of the invention, there is provided a building environment management system comprising the apparatus according to the second aspect.

The second and third aspects of the invention may comprise any of the features described above in relation to the first aspect of the invention.

### BRIEF DESCRIPTION OF THE DRAWINGS

Embodiments of the invention will now be described, by way of example only, with reference to the Figures of the accompanying drawings in which:

FIG. 1 shows a schematic representation of various functions of a Home Environment Management System (HEMS) in accordance with an embodiment of the invention;

FIG. 2 graphically represents a model of thermal comfort;

FIG. 3 shows comfort zone variations for different occupants;

FIG. 4 shows user actions, components and utility usage for an exemplary dishwasher work process;

FIG. 5 schematically illustrates the data structure of persona in accordance with an embodiment of the invention;

FIG. 6 schematically illustrates the organisation of HEMS-related activities that an occupant may perform in a building;

FIG. 7 shows a flow chart of the steps a HEMS in accordance with an embodiment of the invention may carry out on a daily basis; and

FIG. 8 shows a flow chart for assigning work flow to individual occupants.

### DETAILED DESCRIPTION OF EMBODIMENTS OF THE INVENTION

Embodiments of the present invention recognise that people have three critical areas relating to their interaction with energy use:
1) The underlying motivations behind their actions that use utilities such as energy and water.
2) The specific patterns of appliance use (i.e. work flows) that they undertake.
3) The style of engagement that they want to have with the overall system, including with other occupants of the same building and the HEMS itself, i.e. the social and physical interfaces.

Aspects of the invention relate to how the Home Environment Management System (HEMS) of the dwelling where an individual spends much of their time can capture and use their persona and also how this persona can be applied in other situations, including how the HEMS can use the persona of a new occupant (that has been captured by a compatible HEMS in another dwelling over time).

A HEMS is an especially important example of a BEMS, since people expect to have greater influence and engagement over their domestic environment than other places and most people spend significantly more time at home than in other buildings. For these reasons the remainder of this document will describe the application of the invention to a HEMS. However, one skilled in the art will see how embodiments of the invention can be applied to BEMS in other buildings (although learning about an occupant's persona is likely to be easier for a HEMS, whereas a BEMS in a non-domestic building is likely to have a greater role in balancing the needs of different occupants).

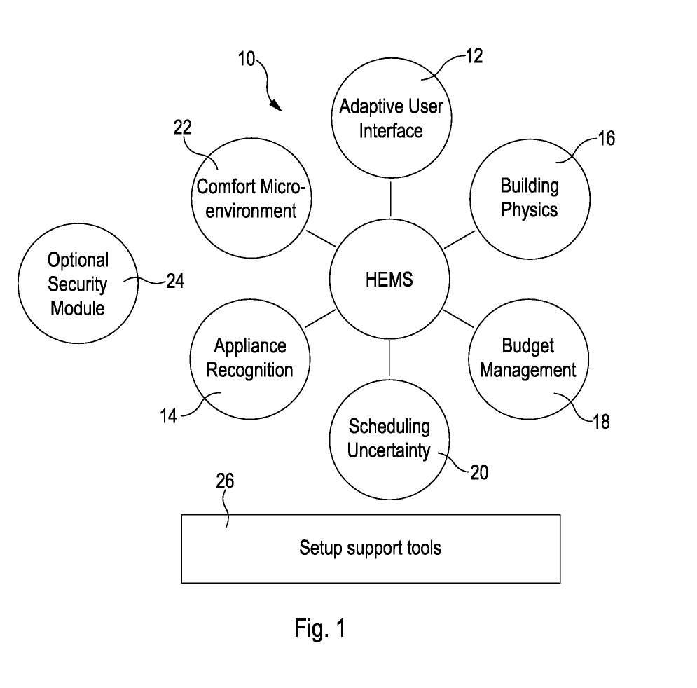

The functions of a HEMS 10 in accordance with an embodiment of the invention are set out at a high level in FIG. 1. Accordingly, the HEMS 10 comprises an adaptive user interface 12 which includes the personas of the present invention. In addition, the HEMS 10 comprises an appliance recognition module 14 (as described in detail in the applicant's co-pending application PB148162 GB), along with modules relating to building physics 16, budget management 18, scheduling under uncertainty 20, and comfort micro-environment 22. There are also set-up support tools 26 and an optional security module 24. It will be understood that the different functional areas of the HEMS 10 need not be provided in discrete modules or units as illustrated but may be partially or fully integrated into the HEMS 10 system. In addition, each HEMS 10 will comprise a local data storage facility (not shown). Furthermore, each individual HEMS 10 will be linked via a network to a central server (not shown) which will comprise central data storage and processing facilities.

### What is Energy Used for in Buildings?

Within any dwelling, the occupants use energy to deliver many services to meet their needs, for example cleaning themselves and their clothes, lighting the building, entertainment, warmth, cooking and preserving food etc. In addition to energy, the HEMS also monitors water use and could monitor other services, such as communications etc. The use of water is so integral to many of the energy using services that, in certain embodiments, it is included in the persona. Other services could be included in a way that will be clear to a skilled person but are not described explicitly. The use of these services is described as activities, things which are important or even essential to life and which can be recognised through patterns of appliance use, are referred to as work flows.

### Drivers of Energy Use

Although the above-mentioned energy service needs are common, people's psychology and physiology impacts on how they think about and use them to produce significant differences. For example, some people are mainly concerned with looking after other people, some would see turning up a room thermostat as self-indulgent, some are concerned about cleanliness and the use of resources, some expect their home to provide a comfortable environment and to pay what it costs, and some people have health problems that are eased by hot baths or warm rooms etc.

Within a single building the occupants reach accommodations on how they share the space and use the appliances. This may lead us to question whether one person is more comfortable than another in colder rooms; whether one person is more concerned about costs and affordability; or whether there is an invalid or small child in the family. The interaction between the different physical, physiological, psychological and social factors leads to major differences in utility use. Even where the buildings and family groups are apparently similar, it is known that energy usage can differ factorially, without a set of simple explanations. In some circumstances economics can be a driving parameter where people are forced to make hard choices about the necessities of life, encapsulated in the phrase “heat or eat”. However in the majority of cases economics is a more secondary factor which impacts through the psychology and social interactions of the occupants.

### Comfort and Achieving it Amicably

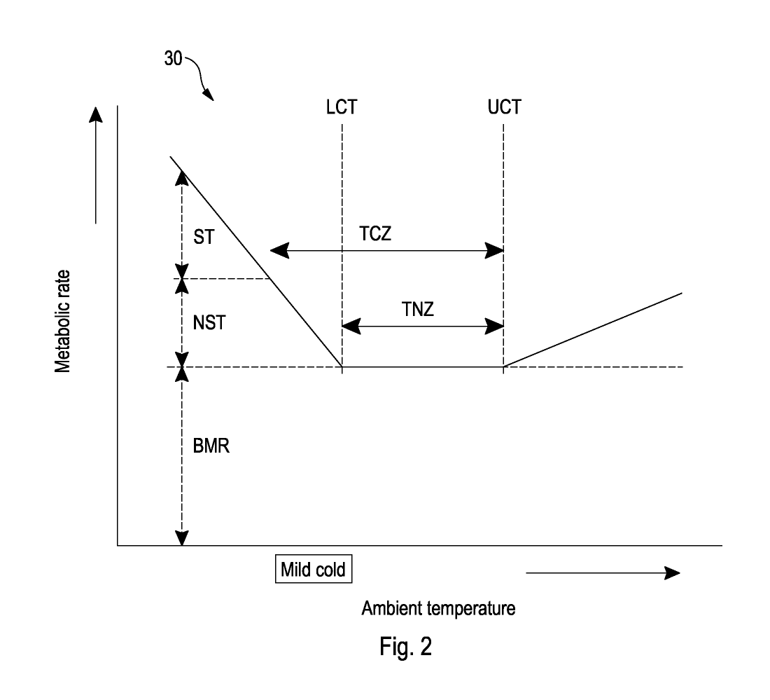

At any moment an individual experience of comfort depends on a range of physical, physiological and psychological factors. There is a strong relationship between clothing, activity level and comfort as exemplified in FIG. 2 which shows a graph 30 of metabolic rate against ambient temperature based on the Predicted Mean Vote (PMV) model of thermal comfort developed by P.O. Fanger and which is adapted from van Marken Lichtenbelt et al.: “Cold exposure—an approach to increasing energy expenditure in humans”; Trends in Endocrinology and Metabolism (2014).

Energy expenditure rests at a basal metabolic rate (BMR) across a thermoneutral zone (TNZ)—which extends between a lower critical temperature (LCT) and an upper critical temperature (UCT)—wherein heat is dissipated by vasodilation and vasoconstriction. When temperatures drop below the lower critical temperature (LCT), nonshivering thermogenesis (NST) and eventually shivering thermogenesis (ST) take place. Above the upper critical temperature (UCT) increases in energy expenditure also occur. A broader range of temperatures (than the TNZ) describe a thermocomfort zone (TCZ), which extends from below the LCT up to the UCT.

People may feel hot or cold because of their activity pattern or clothing or they may change their activity pattern and/or clothing to improve comfort. Adjusting the heating settings on their HEMS may be the first response to discomfort or something they never do.

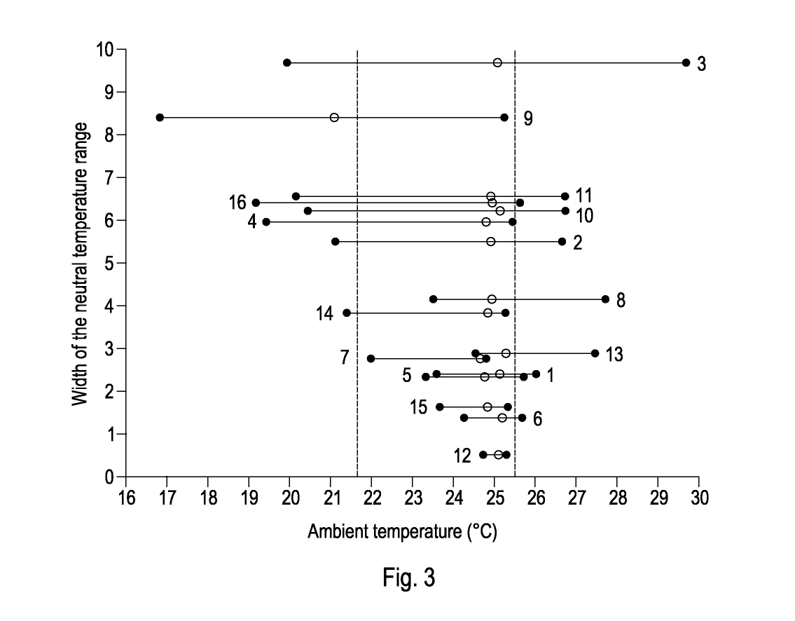

Individuals have different responses, even in a situation that is controlled and standardised as illustrated in FIG. 3, which shows a graph of comfort zone variations for different occupants taken from Jacquot et al.: “Influence of thermophysiology on thermal behavior: the essentials of categorization”; Physiology and Behavior (2014). The black circles in FIG. 3 show the limits of a neutral ambient temperature range for 16 female subjects, each of which were comparable in terms of health, age, height, body mass, body mass index, amount of body fat, muscle and surface area. The white circles on the graph show the median ambient temperature for each individual and the dashed lines show the boundaries (between approximately 21.5 degrees C. and 25.5 degrees C.) for an acceptable thermal environment for all as predicted by the Population Mean Vote (PMV) model.

As illustrated in FIG. 3, people have different experiences of and attitudes towards comfort—some are relatively content over a wide range of temperatures (i.e. subjects 3 and 9) but others have a very narrow comfort zone (i.e. subjects 12 and 6). It will be appreciated that such differences can lead to “thermostat wars” where each subject wishes to satisfy their own level of comfort. For example, satisfying subject 12 could be challenging (due their narrow comfort zone) but combining them with subject 3 appears to be relatively easy as subject 3 has a wide comfort zone that encompasses that of subject 12. Having said that, there could be a conflict if subject 3 wishes to take charge of the “thermostat” and to set the temperature outside of subject 12's comfort zone. Similarly, satisfying subject 9 or subject 8 individually should be relatively easy (as they both have relatively wide comfort zones) but if they share a dwelling, then satisfaction is likely to depend on matching the control actions of the HEMS to the interaction between their personalities because their comfort zones only partially overlap. In other words, if one subject is more dominant than the other with respect to the control of the heating, the HEMS should recognise this from their persona and adjust the temperature accordingly.

### The Potential Benefits

The present description highlights the enormous potential value for a HEMS according to an embodiment of the invention, if it can better meet people's energy service needs cost-effectively, and also the considerable challenges in delivering an outcome that is valued by many different consumers in different situations. There is a paradox that attempting to reduce individuals to automata or the objects of social policy is likely to produce undesirable unintended consequences, whereas focussing on understanding and meeting their needs better is likely to enable the engineering elements of the system to align better with consumers.

Another situation that may create an opportunity for a HEMS in accordance with an embodiment of the invention is in appliance replacement. Given the activity patterns for each occupant in a household, the HEMS could take the specifications and work processes for a new appliance and do a cost benefit analysis. While at first sight this might seem a straightforward exercise in practical economics, perhaps more the domain of the appliance recognition and budget management modules 14, 18 of FIG. 1, the interaction with the user is through the adaptive user interface 12, which can understand what is important to the user from their persona (i.e. whether the user wants to drive the evaluation or is looking for suggestions and insights from the HEMS). For example, a user who always runs the Eco programme on the dishwasher will have a different value on a new dishwasher than a user who always runs Intense (and has a high need for hygiene). A household with a four year old that always leaves the door open on the fridge needs one with an efficient refrigeration cycle, whereas one where the door is only opened infrequently needs one with good insulation. In some embodiments the HEMS may even do estimates of thermal mass against tariff to understand how to use the flexibility in smart devices to reduce utility bills. A user who has high affordability and resource scores may be interested in cost/benefit analysis; whereas a user with only high resource scores may be more likely to be concerned about waste and efficiency; and a user with low scores on all of these but high scores on comfort and hygiene may be likely to be concerned about performance, especially if they live in a family group and have high relationship scores.

### Occupant Needs

Embodiments of the invention involve applying methods developed from social, psychological and physical theory and unpublished research to collect and use information from each dwelling and also compare across dwellings to increase the alignment of the HEMS with its owner's/user's needs. Although thermal comfort has been used as an important example of the issues, the needs stretch well beyond individual thermal comfort. For example, cleanliness and ventilation behaviours are related both physiologically through smell and also psychologically through needs which recognisably vary widely across the population. Just as people have individual thermal comfort needs, they also have widely varying sensitivities to different odours and research predicts that these factors will also be correlated with other less physical needs (e.g. relating to affective needs such as emotional needs, the need for status or stability).

We have described “thermostat wars” as one example but one skilled in the art will appreciate the importance of dominance-submissive behaviours, of teenage rebellion, of nurturing and parenting behaviours, of the sense of shared and individual space etc. and these attributes can all be included in a persona so they can be taken into account in operation of the HEMS.

While it is convenient to use technical language to describe these issues, the design of the system will focus on meeting people's needs effectively, including protecting their privacy and self-respect. An analysis which shows that an individual differs significantly from population norms is not a value judgement about them. The system is grounded on observing and assessing occupation behaviours and how people meet their needs in order to help them meet them more easily, more affordably and in ways that make them feel in control and secure.

Embodiments of the invention enable a HEMS to learn and adapt from its ingoing conceptual structures, so that consumer satisfaction with certain patterns and responses of the HEMS improves over time. Although the most significant relationships could be extracted through conventional data analytics techniques, the complexity and subtlety of the hidden system of building physics, occupant physiological status and state of mind is such that black box approaches will not succeed in interpreting the subtle clues provided by the analysis here described. The processor (i.e. mathematical engine) in the HEMS is looking for patterns but these may be based on a priori hypotheses about expected patterns and especially their meaning (or significance).

### Work Flows, Work Processes and Appliance Data

The applicant's co-pending patent application (our ref: PB148162 GB) describes in detail a method of monitoring appliance usage within a building which comprises monitoring two or more utilities and measuring one or more characteristics relating to each of the utilities to provide an output signal representative thereof; monitoring for changes in the state of each of the output signals at predefined time intervals; and combining data from the output signals from each utility, to identify one or more patterns of appliance usage.

A pattern of appliance usage may comprise a work process and/or a work flow. A work flow comprises a sequence of appliance usage associated with a particular activity such as: i) cooking: switch on light, fill pan, switch on cooker, switch on extractor fan, take food out of refrigerator, use cooker, rinse dishes; or ii) bathing: switch on light, run bath, switch off light, switch on light, use hair drier, switch off light. A work flow may comprise one or more work processes, which relate to a mode of operation of a specific appliance (e.g. lights, washing machines, baths, and televisions). For example, a hair dryer will typically have different heat and fan settings and each combination will constitute a particular work process. Operation of all of these energy and water using devices (i.e. appliances) provides the services that the occupants collectively require.

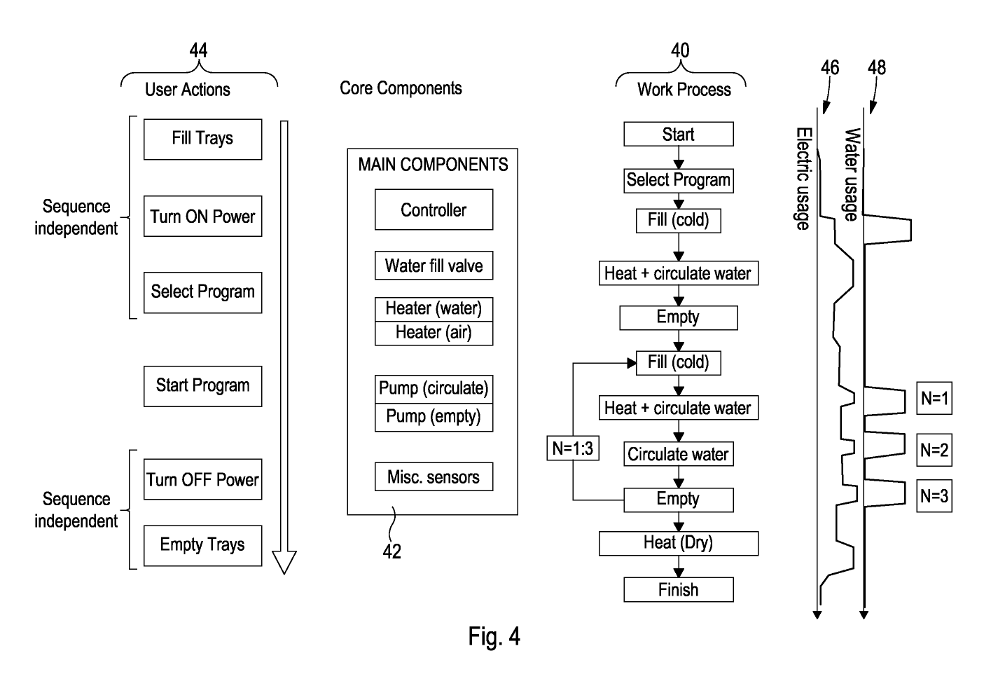

FIG. 4 illustrates a particular work process 40 for a dish washer comprising components 42. Each individual wash programme cycle would constitute a different work process 40 and the elements such as heaters; pumps etc. would be the components 42. It will be understood that user actions 44 will be required to fill the appliance with dirty dishes, turn on the power, select and start a program (e.g. work process 40) and subsequently turn off the power and empty the dishes, although many of these steps are sequence independent. In terms of utility usage, the actual electricity usage 46 and water usage 48 signatures will be dependent on the work process 40 (i.e. program) chosen and will be monitored by the system.

The HEMS will attempt to disambiguate individual lumieres to determine the utility usage signatures of each light so as to determine the location of each one.

The system will use information from a setup procedure and from other interactions with the occupants to try and identify work flows that are clearly driven by one individual and those which are either ambiguous (i.e. the occupant cannot be determined) or a team effort. For example, in embodiments of the present invention, the system will try to identify the occupant carrying out the work process 40 of FIG. 4 and/or, if it is deemed to be a shared activity (i.e. in a family household), may apportion a share of the work process 40 to each of the relevant occupants and will store this information in their respective personas.

In addition to the work flow, work process and appliance data captured and stored by an individual HEMS, it is envisaged that in many embodiments, there will be a central database comprising such data obtained across many dwellings. How this data can be captured and analysed to identify work flows, work processes and appliances is described in detail in the applicant's co-pending patent application (our ref: PB148162 GB).

Furthermore, in embodiments of the present invention, the HEMS, through its adaptive user interface, will gather clues about the style of interaction that each user prefers in order to use its services, as well as clues about environmental preferences.

### Persona Data

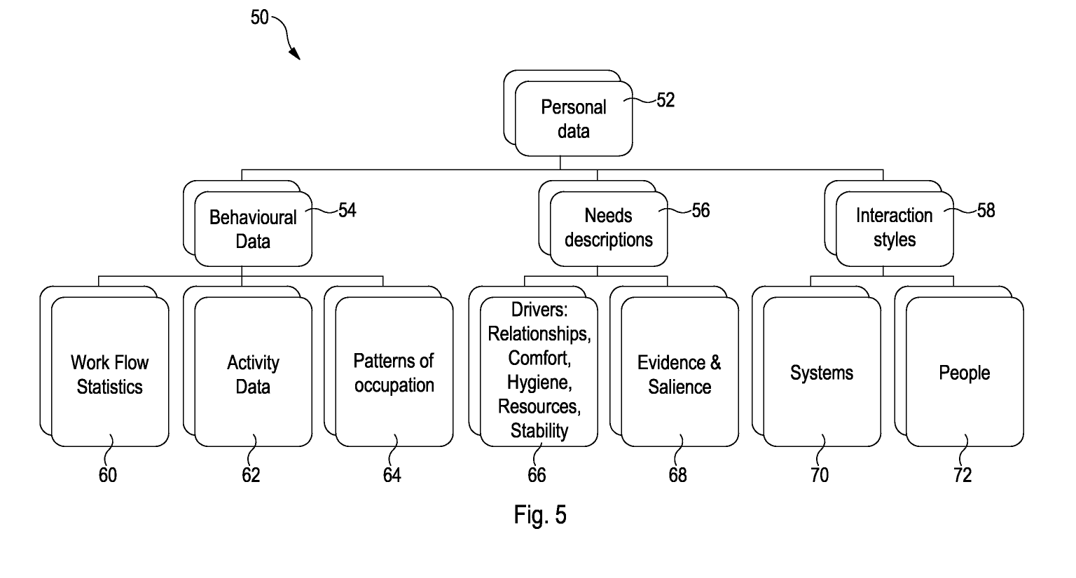

In accordance with an embodiment of the invention, the persona may comprise a data structure 50 similar to that shown in FIG. 5. Accordingly, each persona may comprise personal data 52 at a first level, behavioural data 54, needs descriptions 56 and interaction styles 58 at a second level and further categories of data in a third level. For example, the behavioural data 54 may comprise work flow statistics 60, activity data 62 and patterns of occupation 64. The needs descriptions 56 may comprise information on drivers 66 (i.e. relationships, comfort, hygiene, resources, stability), and evidence and salience 68. The interaction styles 58 may comprise information on systems 70 and people 72. Each of these will be described in more detail below but it should be understood that the data structure 50 is extensible, so that additional information can be incorporated beyond that depicted in FIG. 5. Similarly, some systems may operate with less data than that illustrated in FIG. 5.

Although not shown in FIG. 5, the data may be organised in a hierarchy depending on the relative importance of layers of data to the overall accuracy of the persona and hence the performance of the HEMS. For example, a hierarchy of behavioural data 54 may comprise: i) patterns of occupation 64; ii) activity data 62; and iii) work flow statistics 60.

Personal data 52 may include all information that the HEMS has available about the individual, such as name, age, sex, phone number, e-mail address, key relationships, chosen icon (if relevant) etc. Some of this information will fall into a recognised category, like the examples above and some may be information that is not recognised. Over time, many users providing similar information about themselves may create new recognised categories with multivariate non-linear correlations with other parameters.

Behavioural data 54 may include data for every building/HEMS which has contributed (or is contributing) to the persona. The behavioural data 54 may therefore comprise specific work flow statistics 60 on a per-building basis, activity data 62 on both a per-building basis and also as a generalisation across buildings, plus occupation data 64 on a per building basis. Each of these types of data will be described in more detail below.

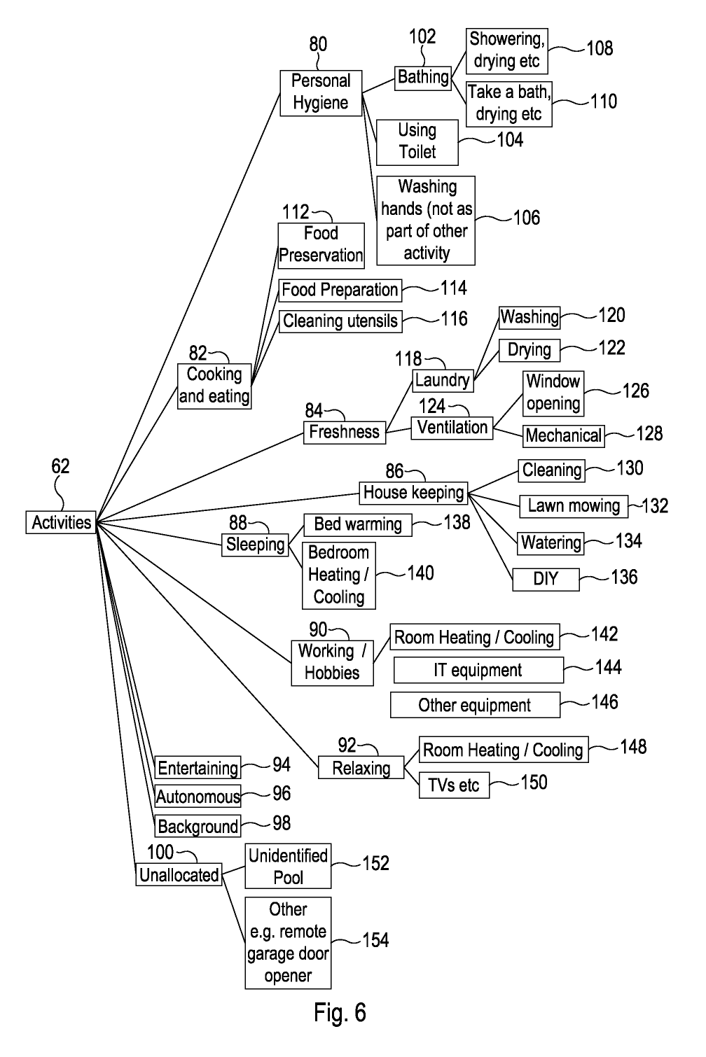

The work flow statistics 60 may list all of the work flows that are identified with the individual (this may include those which are shared and those which have ambiguous ownership—for example, where there is a relatively low probability of the work flow actually belonging to the individual). The data may include frequency by time of day, per day of week and with correlation factors with environmental and seasonal parameters (for example outside temperature, rainfall, daylight timing etc.). The specific work flow statistics 60 may include data on individual work process parameters and the time and spatial relationships between individual work process elements of a work flow. The data may be collected so that individual work flows can have distributions of parameters, including timing and spatial location, but closely related work flows may be grouped hierarchically, ultimately by activity type (such as those depicted in FIG. 6). For example, showering and drying hair by an individual would be closely grouped, even though they are activities that use different appliances and each may comprise different possible work processes giving rise to a number of different work flows. Taking a bath and then using a hair drier would similarly be grouped under the activity of bathing, which also includes taking a shower. More detail on how this hierarchy can be developed is provided below.

It will be understood that, in some embodiments of the invention, the HEMS requires a level of intelligence that allows it to recognise or learn new work processes and appliances and so construct ever more accurate personas and work flows in the future.

Activity data 62 groups work flows (or parts of work flows) together, for example, based on the categories shown in FIG. 6. In this example, activities are grouped under headings including personal hygiene 80, cooking and eating 82, freshness 84, housekeeping 86, sleeping 88, working/hobbies 90, relaxing 92, entertaining 94, autonomous 96, background 98 and unallocated 100. For simplicity, lighting is not shown on the chart, but would be included where it was associated with a specific location and work flow. Running taps could be associated with a number of activities, such as using the toilet, simply washing hands, filling a bucket for housecleaning etc.

As an example, under the heading of personal hygiene 80 there are work flows associated with bathing 102, using the toilet 104 and washing hands (not as part of another activity) 106. Within bathing 102 we have the different work flows associated with showering and drying 108 and taking a bath and drying 110. Cooking and eating 82 can be broken down into food preservation 112, food preparation 114 and cleaning utensils 116 and each of the categories can be sub-divided further in specific work flows. Freshness 84 may comprise laundry 118 (sub-divided into washing 120 and drying 122) and ventilation 124 (including window opening 126 and mechanical vents 128). Housekeeping may comprise work flows relating to cleaning 130, lawn mowing 132, watering 134 and DIY 136. Sleeping 88 may comprise bed-warming 138 and bedroom heating/cooling 140. Working/hobbies 90 may comprise room heating/cooling 142, IT equipment 144, other equipment 146. Relaxing 92 may comprise room heating/cooling 148 and televisual equipment 150.

Autonomous activities 96 may comprise sprinkler systems, security lighting etc., where there is a clear pattern of utility usage, especially if it occurs whether the house is occupied or not. Background activities 98 may comprise all utility usages that appear to be essentially constant, such as standby power use, burglar alarms and other effectively autonomous appliances that are always on. However, refrigeration is better included as part of food preservation 112, since it requires a pattern recognition and integration process to identify the human agency element. Unallocated activities 100 may comprise all utility usages that cannot be allocated to another particular category either because they are unidentifiable 152 or simply because they do not merit their own category and are classed as other activities 154 (e.g. remote garage door opening).

Entertaining 94 may be provided as a holder for work flows that are associated with guests (overnight) and visitors that have not been identified to the HEMS but where the HEMS identifies that there are likely to be additional occupants (e.g. at a party). Where guests are identified to the HEMS, they may be assigned a temporary persona (which is retained in case they return) or they may give access for the HEMS to use an existing persona (e.g. for their home HEMS which may be connected via the central server).

All activities 62 in principle could be shared or individual. Bathing 102 or using the toilet 104 are unlikely to be shared, whereas cooking and eating 82 are very likely to be shared unless the work flow pattern clearly involves an isolated and individual act of preparation and consumption. Even then there will be shared elements of food preservation 112 and utensil cleaning 116, unless the home has a single occupant. The data is therefore split between an estimated share of the benefit of the activity 62 to each occupant and those activities 62 which can be assigned to one occupant.

Ventilation 124 is slightly different from the other activities 62 described above, in that it could be entirely manual (opening windows/doors 126), mechanical 128 (perhaps with manual activation e.g. kitchen extractor fan) or fully integrated into the HEMS (and therefore with inputs that can recognise user intervention and target levels directly, such as for an acceptable range of humidity or a defined period of time for a fan to run on after a bathroom is used).

In relation to the HEMS 10, the Adaptive User Interface 12 and Appliance Recognition 14 modules from FIG. 1 will require inputs from the Building Physics module 16 to recognise the presence of ventilation through heat and humidity balance estimates. Ventilation activities could be driven by the need to reduce the perception of odours, to reduce over-heating, to reduce humidity or just to experience greater closeness and access to a natural environment. The act of opening doors and windows is likely to be suppressed by wind, precipitation and very low temperatures. However, some people have a very high need for ventilation as evidenced by the instances of overnight fan light opening in blocks of flats even during cold spells in winter. Theory suggests that such people are also likely to show higher than modal levels of other freshness activities 84 and may be linked to a cluster of users having a hygiene driver 66.

The data block associated with patterns of occupation 64 in FIG. 5 may comprise when the person is in the building by time and day of the week and any patterns of seasonal variation. It may also comprise activity patterns that relate to how long the person has been in the building, as well as by time of day. The analysis may identify work flows that are so well established that they stretch across multiple activities 62. For example, if someone returns home, washes and changes and then either has something to eat and watches the television or goes out and returns later, these would be captured as two patterns of occupation. In addition to the work flows comprising combinations of work processes, the occupation patterns may explicitly comprise combinations of work flows including location points. Where there are two work flows that are structurally related in terms of their activity sequence, but different in their location, they will be grouped together. In natural language this might be that there is a pattern of occupation where the person comes home and has a shower in the en-suite before eating and another, much less frequent, one where they come home and have a bath before eating. In this case, the pattern of occupation would be seen as the same, but with detailed differences in work flow and location. The structure of the occupation data is therefore by activity patterns but the content is by specific work flows.

Needs descriptions 56 may be synthesized across all of the buildings included in an occupant's persona. In certain embodiments, the HEMS maintains three separate but related sets of needs descriptions: current state, temporary state and long-term needs. This reflects the fact that people behave differently in different circumstances and such changes may be seasonal (for instance recognising the impact of seasonal affective disorder in an extreme case, or just different behaviours between winter and summer at a more simple level), monthly (e.g. different behaviour immediately before and immediately after payday in terms of frugality of energy use), weekly (e.g. happy at weekends, depressed on Mondays), or daily (e.g. need for more warmth in the evening).

The current state may relate to evidence gathered since the person entered the building on the hypothesis that their physiological or psychological status may have been significantly perturbed from the norm by factors such as an argument at work, vigorous exercise, a sunny day etc. so that their long-term behaviour is not a good predictor of their need status at present. The temporary state may be developed from recent evidence, typically over a week or two. This is based on the hypothesis that there may be factors such as illness, financial difficulties, a promotion, a new grandchild etc. that have perturbed the person's status significantly from previous long-term norms. Statistically, the HEMS will look for a moment of discontinuity, so that the temporary status has a starting point (which may not be sharply defined, either due to gradual changes or limited evidence). The long-term state may represent the data gathered over the last year or two. Where the HEMS detects a discontinuity, leading to the hypothesis of a different temporary state, it will start looking for another discontinuity signalling a return to long-term norms. The HEMS therefore has a measure about how significantly different it sees the temporary state from long-term norms. In some cases, what appears to be a temporary state may actually signal a sudden transition to a new, different long-term state due to a significant external event (e.g. birth of a child or chronic illness such as being diagnosed with diabetes/having a heart attack) or a conscious change in lifestyle (e.g. quitting smoking).

Embodiments of the invention use a priori Bayesian hypothesis to draw conclusions regarding what activities are being carried out and by which occupant. The structure of such a priori Bayesian hypothesis does not assume that the current and temporary need states are necessarily drawn from the same population as the historic states, although this would be the initial hypothesis. Also the statistical analysis will test whether the parameters of the historic states are distributed in a way that suggests the underlying processes conform to the Central Limit Theorem or whether they are better represented on the assumption that the underlying processes are chaotic. An apparently different temporary state that is marked by a moment when the current state was unusual statistically will be a strong signal. With the exception of the personal data 52, the content of every other data block in FIG. 5 will contribute to each state, with only the temporal spread of the data being considered, being different.

The underlying needs are described in terms of key drivers 66, determined from direct consumer and psychological research and statistical analysis of data from many HEMS. The structure of the data is inherently extensible, and we likely will encounter new needs as the application of the HEMS is extended across millions of people, even if some of the needs are very rare. For example, the need cluster stability in FIG. 5 represents needs to do with conformity, unchanging patterns of behaviour etc. This might include ritual and repetitive behaviours, for example, to meet the needs of a religion or tradition or to meet other psychological needs. If the statistics show that there is a sub-group of factors that is only weakly correlated with other factors within stability, the sub-group might be split off and have a natural language name of ritual, becoming a primary need and also absorbing factors from other needs that are more strongly correlated, for example ritual hygiene or other repetitive behaviours of individuals and groups.

The needs are represented by activities with additional information about elements that may not involve using appliances, for example a ventilation activity could comprise autonomous operation of a fan, manual operation of a fan or opening of doors and windows. The hygiene sub-group related to freshness could include information about any control set point changes for the autonomous operation as a signal of need related to the activities which prompt autonomous operation; it could also include manual operation as a work process component of a work flow; window opening may be detected by the building physics module which would feed into this being included as part of a freshness requirement of the related activity pattern. Constantly adjusting the temperature of a room might feed into the comfort need or the relationships need, depending on context. The drivers block 66 of the needs data structure contains these structural relationships, along with the parameters—how much, how long, what variance etc. The frequency and intensity of the expression of the need through associated activities, when compared to population norms, enables a weighting for how relatively important the need is to the occupant. Part of the central analysis (performed by a central server) may involve segmentation, identifying clusters of needs that are strongly related in some people. For example, building on the previous discussion about potentially splitting ritual from the needs of stability and hygiene, we could imagine a small segment that has high needs for all three, where a strong reinforcement drives frequent and clear patterns of behaviour. We could imagine another segment, which is also driven by ritual, but not by stability and/or hygiene. Although patterns in such an occupant's dwelling would relate to other dwellings with similar rituals, they would be weaker. Indeed it is the prevalence of this segment that may cause ritual to emerge as a separate driver.

The evidence and salience data block 68 holds the basis for the three temporal hypotheses about the needs. Having a set of three distinct time periods for the needs recognises that people can be in a different state and that their underlying state can change, either suddenly or over time. The evidence and salience block 63 may recognise that the needs states are based on conjecture about partial evidence and that the underlying needs can appear more strongly in some situations than others. For example, comfort related activities are almost inevitably more salient in the winter than the summer. The drivers data block 66 highlights and organises certain activities (based on work flows) for the persona, including the parameters of those activities, such as time between steps, settings or programme selections etc. The evidence and salience block 68 may hold the critical information on why the drivers block 66 holds the data it does. In a new environment, the HEMS can use the drivers data 66 to generate a hypothesis about likely activities, for example which programme(s) are likely to be used on a new dishwasher. The evidence and salience block 68 can be used to (a) assess the strength of this hypothesis and (b) compare new evidence to see how it fits the hypothesis.

Interaction with the HEMS by the User

The interaction styles block 58 describes how the individual operates within their environment to achieve their objectives for utility related activities. The main data structures are per building environment, with an underlying analysis as the basis for projection into new environments. The two main categories are interaction with other people 72 who share the space and with the systems 70 in the building, especially the HEMS. There is a strong linkage between interaction style and needs—people interact with each other and the building systems to meet their needs. What to one person may be an unacceptable outcome due to the behaviour of another occupant or the response of the building systems (including HEMS) to another person may be something that they readily accept. Some people may express and/or take action rapidly and easily to address their dis-satisfactions, others may simmer internally. The main underlying concept structures may relate to social hierarchy behaviours, Myers-Briggs personality types and information processing styles.

The social organisation within a dwelling can be captured in a number of ways. The decision making hierarchy can be described in terms of who takes the lead in making choices (such as temperature settings), depending on who is present when the choices are made. The hierarchy could be weak (if choices are made without obviously deferential behaviours) or strong (if choices are always made by the same person of a pair, until the boundary of the more submissive person is breached). Evidence on nurturing behaviours can be captured in a pair-wise fashion, which could therefore be reciprocal. Priority for resources can be analysed in terms of who makes the choices about them and also who tends to access them first when there is a schedule clash. Priority could imply ownership (“my bedroom”) or just priority (head of the queue for the bathroom) or there could be no obvious priority (“first to the line”). Children and elderly occupants present potential challenges in interpreting their behaviour and that of the other occupants towards them. It may be difficult for the HEMS to ascertain if they are competent or if they attract strong nurturing behaviours. People may be deferred to for what may be cultural reasons or because of their personality. As children grow up they may pass through a period of establishing their separate identity (“teenage rebellion”) and then their separate authority (“leaving home”). The social elements of the personas of young adults are likely to be more contextual than older adults, so translating from their family environment to others may have a degree of uncertainty. Another factor cluster is technical competence plus responsibility. One occupant may be the lead user (“administrator”) for the HEMS because they want to control the environment or because they have the skills to do it or because it was their job to read the manual. Roles and responsibilities may have been assigned within the household, so that one occupant mows the lawn and another does the laundry or it may be down to whoever decides to do it first. The assignment is likely to combine elements of competence, time availability, interest and social expectations, which are culturally dependent. The reason for organising this information in this way is to understand which occupant makes choices about what, who has priority for which resources, and when and how to navigate conflicting objectives. Where people show behaviours directed towards the needs of others, these will combine nurturing, dominance, competence and social responsibility elements in some proportions. The person responsible for operating a shared activity of collective benefit is likely to have a degree of ownership and authority over the tools for the job (e.g. dishwasher, iron, HEMS) whereas personal appliances like phones and hairdryers are more likely to be “owned” and operated by occupants independently.

Central to the systems interaction data block 70 is the interaction with the HEMS, but it may also record all other “touches” on control system elements such as thermostatic radiator valves (TRVs), and analysis of the “ownership” of space (i.e. rooms) within the building and an analysis of activity and appliance “ownership”. Ownership is not a binary descriptor; it ranges from a space, appliance or activity being only very rarely associated with a person other than the owner, through multiple people being associated in the absence of a primary owner to an apparent lack of any clear owner or owners. The scale may be determined by relative levels of engagement in relation to the presence and absence in the dwelling of different occupants at the times when the entity is likely to be occupied or used. There is a subtlety in relation to spatial location. For example: the fridge in the granny flat may appear to belong to grandma and the shower in the main bathroom may appear to belong to the daughter in a household but housekeeping activities may appear to cut across these. The interaction style with the HEMS may be determined inevitably from interactions and the way that the HEMS adapts in response to user inputs. The user interface itself may hold all the specific user information which is bound onto the specific instance of the HEMS and building, including dialogue structures, user preferences, dialogue status etc. The persona may hold metadata which can be translated onto other instances of buildings and HEMS and also applied to develop hypotheses about new user interactions within the existing system—for example to choose which of three budget analysis screens to offer the first time the user wants to budget, given likely user preferences. More specifically, the system may be configured to make inferences about user interface preferences from hypotheses developed from other behaviours within the personas and clusters. Over time the data from many thousands of HEMS will improve the structure and a priori probability weightings in these hypotheses.

How the HEMS could Work

In the following discussion of alternative hypotheses and probability weightings, it should be understood that the HEMS is constructing Bayesian networks to calculate the values described. Furthermore, the networks may be pruned of relatively low probability branches to avoid excessive complexity and calculation times. This is a distinct advantage of embodiments of the present invention.

As each occupant returns to their home, the HEMS, according to an embodiment of the invention, is attempting to detect the signature of a new arrival. This could be as trivial as the burglar alarm being connected to the HEMS and the system detecting the deactivation of the burglar alarm or it could be through the detection of a smart phone entering the building (or connecting to a local WIFI router or the like). In some embodiments, the detection of an occupant may be through energy use signatures, such as operation of lighting, or motion sensors. For example, each occupant will have a set of signature work flows that are associated with returning home, including the timing, and non-work flow cues such as adjusting room thermostats. Accordingly, within the relevant time periods, the HEMS is looking for relevant patterns of occupation.

At any moment the HEMS may have multiple hypotheses of the occupancy state, with estimated probabilities for each. The a priori probabilities of occupancy patterns of the residents will represent a “ground state” for this estimation. In many circumstances it may be hard to gather additional information. For example, if the occupants typically spend Sunday afternoon playing cards, then it may not be clear if anyone is in the building until lights are switched on or someone fills and switches on the kettle. Data gathered in the winter will provide a stronger ground state than data gathered in the summer, due to lighting. It should be noted that the absence of evidence regarding occupancy is not necessarily evidence that the occupants are absent from the building.

Since the hypotheses propagate forward in time, through periods of sleep, who is in the building could become open to significant ambiguity. It should be noted that a significant amount of exogenous structure will be required in forming these hypotheses, based on a general understanding of human nature and activity and comparison with others from the central server database, with a hypotheses that geographically closer dwellings may be more representative of a particular dwelling and a counter hypothesis that they are not.

Based on the estimated occupation, the HEMS will assess the extent to which occupancy behaviours are within typical parameters. If they are within the parameters for the long term patterns of all of the occupants, then the ground state hypothesis that all is normal will have a dominating probability assigned to it and will therefore be the “working hypothesis”. If this is not the case, then there are a number of potential hypotheses that could be weighted in different measures. Table 1A illustrates how this might work in a two person household where the HEMS detects a slightly unusual behaviour pattern. Only hypotheses that are above a cut-off probability are shown (since the least probable outcomes are not of great interest). In this example, we note firstly that each occupant has shown short-term behaviour (on previous occasions) that is not consistent with long-term behaviour patterns. Given that short-term behaviour will include aspects of long-term behaviour and will have a limited evidence base, we would expect to have multiple hypotheses when both of the occupants have a different short-term behaviour.

The example of Table 1A below illustrates a situation where something unusual is happening, with limited evidence on what it is. There are enough atypical work flows occurring that the HEMS cannot tell whether there are likely to be visitors in the dwelling, but it is a plausible explanation that should be considered. Equally there have been enough examples of typical behaviours that the hypothesis that things are generally normal (although slightly unusual) is actually the most likely, even if not especially compelling. The complete set of intermediate possibilities has not been enumerated but one skilled in the art can see that there are many combinations, each with a relatively low probability. There are potentially many situations which could lead to this kind of hypothesis table. For example, where new grandparents are being visited for the first time by the parents of their first grandchild, early on a winter's evening, the activity patterns of the grandparents may be slightly unusual although they are generally doing what is expected, prior to the visit. One of the consequences of the grandparents having slightly unusual behaviours in the days running up to the visit is to create uncertainty about their current behaviours, which makes it harder to distinguish the presence of visitors.

TABLE 1A
Occupancy hypotheses example for two dwellers, where the HEMS
detects a slightly unusual behaviour pattern

| | Occupant | Occupant | One | Multiple | Probability |
|---|---|---|---|---|---|
| Present | A | B | Visitor | Visitors | (%) |
| Hypothesis 1 | Long-term | Long-term | Absent | Absent | 15 |
| Hypothesis 2 | Long-term | Short-term | Present | Absent | 10 |
| Hypothesis 3 | Short-term | Long-term | Present | Absent | 9 |
| Hypothesis 4 | Short-term | Short-term | Absent | Absent | 7 |
| Hypothesis 5 | Current | Long-term | Absent | Absent | 5 |
| . . . | | | | | |
| Hypothesis n | Current | Long-term | Absent | Present | 3 |

Table 1B below represents a situation where someone is clearly in the house at a time when neither occupant would normally be there and is following a pattern of behaviour that is not typical of either occupant. In this situation, the HEMS has no real data to distinguish between either of the occupants being in an atypical current state or the presence of a person or persons unknown. A cat sitter using their key to enter the property and prepare cat food in the kitchen could give rise to this kind of pattern or it could be an intruder or one of the occupants returning home at an unusual time and for some reason (for example illness) behaving atypically. If the HEMS has security functions it might recognise that the alarm had been set by the occupants and then unset by the visitor. If it does not, then the HEMS might text a message to the owner that there is an unrecognised person in the dwelling, depending on the owner's interface preferences. Over time, the pattern of activities being carried out may start to increase the probability that this is one of the occupants in a current or short term state. This might happen in a relatively short time period or may take several days. Disambiguation may not occur until an occupant shows their identity, for example, by accessing the HEMS from within the building. As mentioned previously, in embodiments of the invention, the HEMS may use IT infrastructure to identify users and/or their devices, for example, by detecting whether a user interface device (i.e. mobile telephone) is located inside or outside the home network firewall and IP address range when operating the HEMS.

TABLE 1B
Occupancy hypotheses example for two dwellers, where the HEMS
detects a very unusual behaviour pattern

| | Occupant | Occupant | One | Multiple | Probability |
|---|---|---|---|---|---|
| Present | A | B | Visitor | Visitors | P (%) |
| Hypothesis 1 | Current | Absent | Absent | Absent | 25 |
| Hypothesis 2 | Absent | Current | Absent | Absent | 25 |
| Hypothesis 3 | Absent | Absent | Present | Absent | 25 |
| Hypothesis 4 | Absent | Absent | Absent | Present | 25 |

The HEMS may use the current occupation hypotheses to form a short-term operating view about the needs of the occupants and how best to meet them. In a typical current UK household, scheduling involves managing the heating system and the hot water supply. In future, with a greater degree of electrification, managing energy services could involve juggling different tariffs, limited connection capacity and energy sources that are more complex and also more constrained than a typical combination boiler.

### Operating the HEMS on the Basis of a Persona

In the following embodiment of the invention, the building uses a gas boiler with a hot water tank, a zone with circulating radiators and zones of individual underfloor heating to illustrate the principles. Also, an en-suite shower room is fed from the hot water tank and the main bath includes an electric shower. It will be understood that operating the HEMS to take into account the thermal masses of the various parts of the heating system and building in relation to the occupation patterns, building physics and weather patterns depends on the short-term forecast for these parameters.

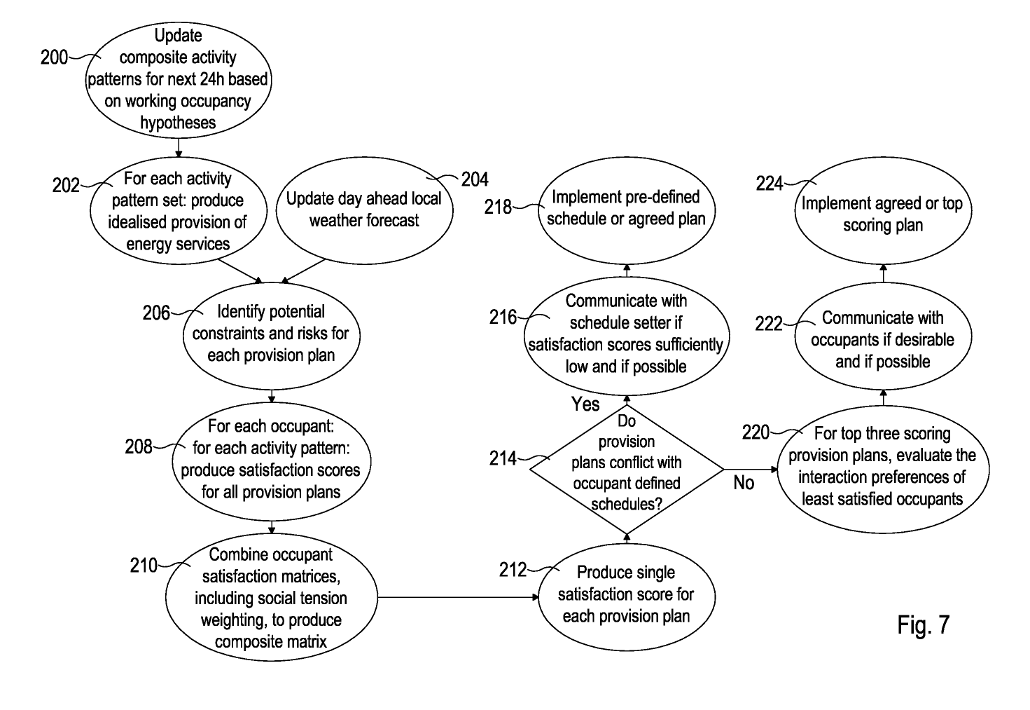

In this example household, one of the occupants normally has a regular pattern of leaving and returning to the house during the week, where they have a bath in the evening. Sometimes they get up very early on a Tuesday, have a shower in the en-suite and leave the house without eating. This pattern of behaviour is frequent enough that on any given Tuesday they might be going to do this. FIG. 7 shows a logic tree whereby the HEMS decides what action to take with respect to the heating and water systems in view of this information, which is stored in the occupant's persona.

The first step 200 is to update a composite activity pattern (using activity data from each persona) for the next twenty-four hours based on the current occupation hypothesis (as determined above). In other words, the activity pattern update uses the occupancy and activity content of the personas of the potential occupants to identify what they might be doing in the next twenty-four hours. This will include entertainment of visitors as a potential set of needs. Each of these day ahead activity patterns will be assigned a probability weighting. The HEMS will discard all patterns with a probability below a certain threshold (e.g. of less than one in sixty which corresponds to an activity plan happening less than once in a two month period) in order to make the analysis tractable and on the basis that the system should not act on the basis of rare events without instructions. The hypothesis about required activity patterns can be modified in two ways: either by user defined schedules or by other user input about their activities (e.g. preannounced guests, information about holidays or input such as “up early tomorrow”). All of this information will contribute to the weightings for each plan.

The next steps include producing an idealised provision of energy services for each activity pattern 202 and updating the local weather forecast for the day ahead 204. The HEMS will therefore produce a set of target parameters in terms of a schedule of services which may comprise room temperatures over time, use of hot and cold water, and use of other appliances. Armed with the weather forecast, the system will estimate modifiers to occupant comfort parameters, ventilation behaviours, heat losses and solar gain, including uncertainty ranges on these factors.

The system will then produce utility provision plans and identify potential constraints and risks associated with each plan 206 such as: overload of system capacity, risk of buying energy services at high cost, risk of under and over-heating (due to solar gain uncertainties), non-overlap of occupant comfort parameters due to weather impacts on psychology etc.

For each activity plan, for each occupant, the system will calculate a satisfaction score for all provision plans 208. This calculation (which can be considered as a satisfaction matrix) will assess the merit of each provision plan against the drivers of that occupant. Scoring each plan against all possible activity patterns for the day ahead, enables the identification of plans that have a low risk of dissatisfaction, even if the actual activity pattern is different from the one for which the plan was defined. The scoring is complex—an occupant can only be physically dissatisfied if they are present, but spending excessively could dissatisfy some people who are not present and people with a high relationship driver will be concerned about the comfort of others, who may well be present when they are not. The occupant satisfaction matrices, including a social tension weighting, are then combined to produce a composite matrix 210.

The individual occupant scores for each provision plan are then combined into a single score for that provision plan 212. The system will then check whether any of the provision plans conflict with an occupant defined schedule 214. If they do, the system will communicate with the schedule setter if the satisfaction scores are sufficiently low and if possible 216. The system will then implement the pre-defined schedule or an agreed plan 218.

If the plans do not conflict with an occupant defined schedule, the system will filter the plans down to the top three using the satisfaction scores (although another number may be chosen in a given system) and will evaluate the interaction preferences of the least satisfied occupants 220. The system will then communicate with the occupants (if that is considered desirable based on their persona) and if possible 222 before implementing the agreed or top scoring plan 224.

During this process, the top scoring plans may be further scored against two other considerations:
1. The inherent risk due to uncertainties in the input data of delivering individual dissatisfaction (e.g. due to no bath water being available, a room being too hot or cold, money being spent excessively or wasted etc.)
2. Finally they may be analysed for the risk they present to the social dynamics of the occupants.

Where the occupants desire a high level of interaction with the HEMS it may need to consult them either where the pre-defined schedule requires significant modification to avoid dissatisfaction or to choose between provision plans that all have a significant risk of dissatisfaction or social tension.

The nature of that communication in terms of style and content will be very much adapted to the user by means of the adaptive user interface module. However, the HEMS should attempt to isolate the issues in a way that makes them clear, as well as clearly presenting the underlying choices. In the present example, the HEMS might ask the user whether they want the system to extend the water heating and heating in the bathroom in case the user wants a shower early in the morning.

In most cases the risk of dissatisfaction from having to respond to the HEMS will outweigh the potential dissatisfactions from the HEMS acting without input. Also, the user may simply not respond in time. If users have implemented a schedule, then only very minor (unnoticeable) adaptions are likely to be acceptable. If they have not, then the HEMS in many cases can just get on with the implementation of the best plan it has determined.

The operating relationship between different instances of HEMS and their dwelling occupants will diverge significantly over time. Although one can recognise in general terms potentially typical outcomes, such as the hands-off household that lets the HEMS implement what it decides is best and the controlling planner who has specified everything, the flexibility of the adaptive user interface and the subtlety with which the HEMS analyses clues to personality can create many thousands of different outcomes in terms of specific detail. If well implemented, these subtle differences in operation should be unremarkable to the occupants, as they effectively get what they expect and need from the system.

### Data Structures

This section describes how the HEMS may create and update the data structures it requires in certain embodiments of the invention.

As explained above, the behavioural data 54 in FIG. 5 is built from work flow data. How appliances are recognised and operated in terms of work processes and work flows is described in detail in the applicant's co-pending patent application (our ref: PB148162 GB). For the purposes of the present embodiment of this invention, we will assume that most work flows can be recognised, even if some of them comprise only a single work process. The present HEMS is looking for clues about occupancy and the person driving each previously recognised work flow. Unrecognised work flows will be stored in the unidentified pool 152 shown in FIG. 6.

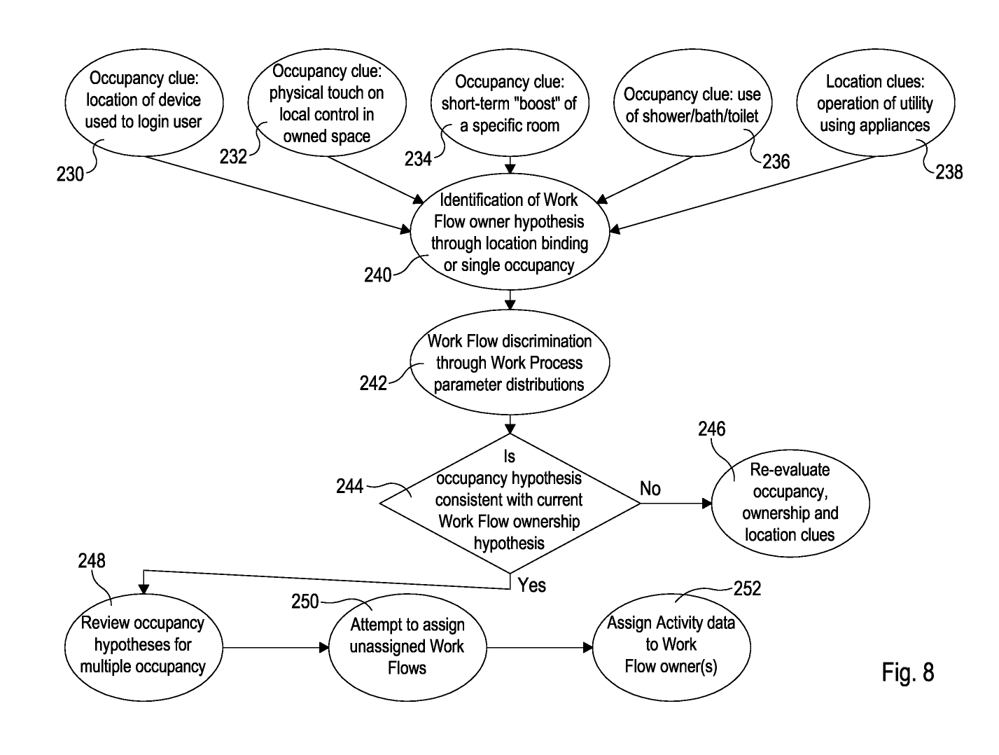

FIG. 8 shows a flow chart illustrating how the HEMS may assign work flows to individual occupants. Feeding into this analysis are several possible occupancy clues. One occupancy clue may comprise the location of a device used to log the user into the system 230. Another occupancy clue may comprise a physical touch on a local control in a user owned space 232. A further occupancy clue may comprise a short-term ‘boost’ of energy requested for a specific room 234. A yet further occupancy clue may comprise use of a shower/bath/toilet 236. A location clue may also be provided in the form of operation of a utility using appliance 238. Each of these clues may feed into a step comprising identification of a work flow owner hypothesis through location binding or single occupancy data 240. The next step may comprise work flow discrimination through work process parameter distributions 242 followed by checking whether the occupancy hypothesis is consistent with the current work flow ownership hypothesis 244. If it is not consistent, the system will re-evaluate the occupancy, ownership and location clues 246. If it is consistent, they system will review the occupancy hypothesis for multiple occupancy 248 before attempting to assign unassigned work flows 250 to their owners. The system may then assign activity data to the work flow owners 252. As mentioned previously, some work flows may involve a “team effort” (e.g. cooking together, watching TV together) and in which case each occupant may be apportioned a share of the work flow.

The HEMS may include a map of the dwelling that was produced as part of an engineer setup activity. The location of major appliances will be shown on the map. The timings in the work flow may therefore have strong clues about physical co-location. Clues from work flows that differ only by the presence of lighting between summer and winter can help with location and owner. For example, using a bathroom in the summer may not require lighting but in the winter it most likely will. Therefore attempting to disambiguate the lighting by other spatial clues is important. The extent to which the appliance recognition module can disambiguate lumieres may therefore become critical to occupancy evidence and a key part of behavioural data construction. Times when there only appears to be one occupant are also opportunities to identify work flows that represent their activities.

The ownership and use of space also provides clues about who is driving a work flow. Although the work flows are simply patterns of appliances using utilities over time, the activities that motivate their use can represent human behaviours that can give many spatial and behavioural clues. Some spaces could be identified through the setup process, provided the engineer has appropriate soft skills training. Bedrooms will likely have identified ownership and this can be extended by geometry to en-suite bathrooms. Using a bath in the main shared bathroom might not be a strong clue if there is no bath in the en-suite, but using a shower is, unless the en-suite is already in use.

Another source of data is “touches” on the control system. The HEMS will be able to detect when someone adjusts a room thermostat or TRV. It will identify when someone uses a wall mounted HEMS interface or a stationary PC and also when they use their phone, tablet or notebook to access the HEMS via an app. By using the low level functions of the device OS and router, the HEMS can identify MAC addresses, IMEI numbers, what name the hardware has been given (e.g. Andrew's iPad) and the nature of the connection, especially whether it is inside the building or not. It may also recognise each user through the ID that they use to sign onto the system, which will give strong clues about the social ownership of various resources, including: space, money, activities etc.

### System Configuration and Set-Up

An initial system setup process by the lead user (administrator) and individual account setup by all users are a significant opportunity to gather user information. In the case of hands-off users, this may be the only significant opportunity for interaction. Where an installation engineer is asked to setup the system, effectively acting as proxy for the lead user, then it is important that they record this and capture information from the occupants which can help make future interactions with the HEMS as easy as possible. Starting the relationship with a new HEMS in a positive manner will require a degree of social skills by the installation engineer.

The functions of the adaptive user interface and how it develops from a starting position to personalised interfaces for each user are described below. However, as each user learns about the HEMS and what it can do for them, the HEMS also “learns” about the users, their interface preferences, typical topics of interaction (for example budgets and costs, or schedules or comfort parameters or fine tuning users' access rights) and their underlying activities. Factors such as how long the user takes to select options, whether they always select the obvious/most popular option etc. will provide key clues to input to the user's persona.

The setup process should offer users choices which aim to uncover how they process information, what topics they are interested in and whether they want to get deeply involved with operation of the system or not. By the end of the setup, not only should the interface for the user have diverged significantly from other users but the HEMS should have significant clues about their personality and needs. Where users continue to interact with the HEMS, it can gain a much deeper insight into their needs, especially if they are open to providing feedback. For example, the HEMS could ask the user if it needs to change anything because the user adjusted a radiator thermostat. The concept behind the adaptive user interface is that it has the social skills of a hotelier or butler, not a software engineer. For example, it would never offer a basic user an advanced user choice during setup. That might be a combination of intimidating and patronising for many people.

The setup process may therefore have three purposes, in descending order of importance:
To build user confidence and capability in future interactions with the HEMS and, through the HEMS, with building systems.
To uncover aspects of user personality and preference that enables the HEMS to do a better job for the user.
To develop an initial configuration that provides a basis for early operation of the HEMS and a starting point for mutual learning of how to work together effectively. In the case of hands-off users, this configuration may continue to be in position as the user interface for a long time. However, the HEMS can adapt, so that the interface is actually very different at the second level and below and the first level may have subtle differences which are important. Also, depending on the analysis, how the HEMS operates can change significantly without explicit user input, depending on how the HEMS assesses the needs of the users.

Some of the potential key dimension indicators relating to the adaptive user interface are illustrated in Tables 2A, B & C below with reference to different personality types or characteristics. More specifically, Table 2A illustrates some control dimension indicators, Table 2B illustrates some planning dimension indicators and Table 2C illustrates some comfort dimension indicators. The dimensions of planning and information processing are important interaction styles while comfort is a need (or driver) dimension. There is a construct of affordability, which is partly to do with disposable income in relation to utility bills and partly perceptual. Affordability is the name of a set of interaction styles within the system, which can also have significant links with the social interactions and the resource driver. The interaction between these dimensions produces different behaviours and requirements of the HEMS. An intellectual planner with limited financial resources and who cares about their young child's well-being will behave very differently from a physical experiencer with a high income but similar feelings about their children.

TABLE 2A
Control Dimension indicators (approach to gaining agency)

| | Interaction Style | |
|---|---|---|
| | Physical (related to Myers- | Intellectual (related to Myers- |
| | Briggs Type Indicator “S” for | Briggs Type Indicator “N” for |
| | sensing) | intuition) |
| User takes | Makes adjustments and looks | Studies help files and |
| charge | for clear physical feedback. | experiments with settings. |
| | Reacts quickly if results not | Persists with engagements |
| | satisfactory. Uses help | over time. Wants requests for |
| | function when frustrated. | feedback, but only if |
| | | specifically set up by user. |
| User | Does not use HEMS interface | Sets targets and leaves HEMS |
| delegates | much, apart from over-rides. | to control. Makes adjustments |
| | Tends to make adjustments | occasionally. Dislikes requests |
| | fairly frequently at local | for feedback unless well |
| | control points (e.g. TRVs). | aligned with needs. |

Individual users will start at different points in terms of taking charge or delegating as their natural style. The aim of the HEMS is to increase the level of delegation by operating well and increasing the trust and confidence of the user. Some users will have a high need to take charge which limits the progress along this axis that is desirable. Social interactions between several students sharing a flat, where one dominant person is an intellectual planner with a high resource driver score and another is a dominant physical experiencer with a high relationships score will be challenging. At least within a family group the basis of decision making will likely be established already by many other choices than operating a HEMS.

TABLE 2B
Planning Dimension indicators

| | Interaction Style | |
|---|---|---|
| | Planner (related to Myers- | Experiencer (related to Myers- |
| | Briggs Type Indicator “J” for | Briggs Type Indicator “P” for |
| | judging) | perception) |
| User takes | Frequent access to planning | User sets up profiles that |
| charge | function to review and update | make changing configuration |
| | schedules. High risk of | easy, when plans change. |
| | dissatisfaction if HEMS alters | Tends to use remote |
| | plan. | function a lot. |
| User | Happy to have a plan that | Very limited interactions with |
| delegates | operates continuously and | controls. Tends to use local |
| | predictably. Uses local | controls. Very happy if |
| | settings and over-rides to fine | HEMS learns from this. |
| | tune. Very high | |
| | dissatisfaction if HEMS | |
| | unpredictable. | |

The riskiest users from the HEMS perspective are those with a high need for stability, who are likely to be averse to new technologies, who are also planners and experiencers with a high need to take charge. Although the comparison is not exact, the characteristics of the ISTJ (introversion sensing thinking judging) Myers-Briggs type indicator may illuminate the issues. Fortunately, people with these characteristics are likely to be very late adopters of a new type of HEMS and will be less influenced by the opinions of others. Unfortunately, they make up a relatively high proportion of the population and some of them will end up with a HEMS through other routes than active choice.

TABLE 2C
Comfort Dimension indicators (approach to hedonics)

| | Interaction Style | |
|---|---|---|
| | Need very salient | Need not salient |
| User takes | Fine discrimination in | User tends to set similar |
| charge | temperature settings by space | temperatures over space and |
| | and time. May well discover | time and only make |
| | and use Summer/Winter | adjustments when there is an |
| | functions (with different | event that prompts them. |
| | priorities/requirements for | |
| | each). System may find it | |
| | difficult to deliver on these | |
| | factors (i.e. outcome may be | |
| | difficult or unrealistic). | |
| User | User leaves settings alone but | User does not change initial |
| delegates | makes frequent adjustments to | setup values. Infrequent |
| | local controls if dissatisfied. | adjustments to local controls |
| | HEMS needs to interpret | are therefore an important |
| | carefully. | signal. |

### Developing the Personas

In embodiments of the invention, (typically every month) the HEMS may start a background process which analyses the last two years (or so) of data to update the personas of the occupants. This process may also be started by a previous month's run scheduling an early restart or an event of major user dissatisfaction triggering a reconsideration of what is going on (i.e. a significant new input). Such events would be signalled by unusual changes in the way that the user interacts with the HEMS, especially if the user selects any majorly negative feedback options.

A first pass of the analysis may compare the occupancy hypotheses over the period with the current (in time) data. When the HEMS is operating in real time, it has a set of working hypotheses about occupancy that propagate forwards and can only take account of historic work flow patterns. In the present review mode, the HEMS can use data from before and after events to test occupancy hypotheses. For example, if someone is ill, the HEMS can distinguish this as a period when the temporary state was different from the long-term state and review occupancy hypotheses accordingly. If users have provided explanations for temporary states that might be recurrent, then the HEMS can isolate them as exemplars. If the user chooses to work closely with the HEMS, this can enable it to seek input about whether the user is ill, tired or upset and can act accordingly. Instances where a user is inebriated might also be detectable through work flows as a separate state, potentially associated with the activity of entertainment. In real time the HEMS is responding to events in the light of experience. In review mode it is analysing what was happening, based on all the available evidence.

In real time the HEMS may construct relatively fine-grained hypotheses about occupancy, since it is trying to meet the needs of all the occupants. In review mode it only needs to be clear when the principal occupants were present and which activities they were involved in. When occupancy is uncertain, the system may pay little attention to the data, unless there is a strong signal of dissatisfaction in that period. Such a period would be “cut out” for separate analysis rather than lumped with the data associated with relatively unambiguous occupancy.

In a second pass of the analysis the HEMS may collect data from the adaptive user interface module on all the user interactions with the HEMS and building systems, including any unambiguous data about operation of appliances etc. within the time periods when it was confident on occupancy or the source of the interaction could be deduced from user identity information. There is a subtlety here about testing the hypothesis that occupants are sharing a user ID and/or a device. If they are, that is an element in their social interaction style as well as posing a challenge for the system to determine the individual occupant activities.

In a third pass of the analysis the HEMS may test the hypothesis that the existing data block structures on Needs 56 and Interactions 58 are consistent with the data and may update the frequency data.

In a final pass the HEMS may test whether it has sufficient explanations for evident user dissatisfactions. Clearly the HEMS will take a precautionary approach for the first several months of interaction with a new user or domestic group and will assume that the user will adapt their system interface behaviours and needs over time, for quite some time, possibly as long as two years. The period of two years is ideal so as to enable seasonal comparisons between a first and second winter, for example, as part of the overall hypothesis testing. However, another period of time could be used if deemed appropriate.

### Handling a New Persona

When a HEMS is presented with a new occupant and user, it can start to build up a persona for them. However they may have a compatible persona already available from another building. In which case, the HEMS will translate the existing persona into the present building and occupant group. At one level it should be fairly clear how to approach this. However some specifics will help to illustrate how this can be done and illuminate what this means for the data structures of FIGS. 5 and 6.

First the HEMS may evaluate the Interaction Styles block 58 to configure the adaptive user interface and style to the new user. For this purpose, the structure of previous menus etc. from the other HEMS will need to be represented in a meta-style. The new HEMS and building may have different systems and different HEMS software but it needs to know, for example, that the user likes a weather forecast on the top menu and that they like to see schedules and budget plans. If the user likes engaging with the HEMS it can have quite a dialogue with them about their needs and preferences, tailored to the issues that matter to them.

This interaction could go well beyond settings and schedules, for example it may be that a previous occupant had a narrow comfort zone (such as for subject 12 in FIG. 3) and the previous HEMS had difficulty avoiding solar gain problems and also a cold zone close to a main window. Although the temperature in the new building may be easier to control, the system may suggest that the user could find a room in the new building to be uncomfortable at one end or the other. There could also be quite a discussion about schedules, for example, if the new dwelling is a significant distance away from the previous dwelling (e.g. due to a longer commuting time). Where a user has paid attention to budgets, the HEMS can ask if a budget estimate is required for their share of energy bills etc. For a user with a very limited desire to interact with the HEMS, the system should choose one or two top issues at most on which to seek input, probably in quite a passive way—for example, by placing options on the introductory menu to see what the user does with them.

In addition to establishing the relationship with the new user and trying to understand their needs, the HEMS also needs to understand the impact on the existing users (if any). For example, a new user with a high need for comfort, low on relationships, a high need for hygiene and stability and a statistically unusually low concern for resources could be challenging for many households. If another user scores highly on resources and affordability (i.e. has limited funds), then that other user might appreciate a budget spread and estimate on a before and after basis. Positioning this to avoid inflaming tensions and getting in the middle of those that are inevitable will again require the tact of the hotelier and not the software engineer. Equally the new user (for example, a student sharing a flat) may appreciate a budget estimate before they decide to accept an offer of accommodation.

In another example, a HEMS user may develop a persona based around their patterns of behaviour in their home using their own appliances. If that user then visits a relative for a week and the relative has a compatible HEMS but a very different home and set of appliances, the user's persona can be translated into the relative's home in order to try to limit dissatisfaction of both the user and the relative. In this situation, there may need to be learning period in which the user's persona is ‘calibrated’ with the relative's home. In some embodiments of the invention, a central server may collate data on work processes and work flows associated with the personas of related individuals or social groups so as to accelerate the learning process for a HEMS when one user visits another in the group.

### User Interface Adaptation

User interactions with the HEMS and the heating system give clues about their thinking and interaction styles. Tables 2A, B and C show three key dimensions of this but there are other styles to do with the interface itself, for example:
Does the user prefer graphs, charts or numbers to present information?
Which design elements do they interact with—menus, information elements or “buttons”?
Which devices do they use to communicate with the HEMS—mobiles, tablets, a PC or local controls in rooms?
Do they communicate as a series of brief touches or in significant sessions and is there a content difference between them?
Do they communicate from within the dwelling or remotely and is there a content difference?

As the user indicates their natural preferences through usage, the interface can adapt to offer choices in the preferred style:
Topics that are often discussed rise closer to the home menu.
When a user requests information on a new topic, the presentation is chosen to match their preferred information style—graphs, charts or numbers.
Similarly actions are attached to the elements that users prefer, so a user that likes buttons will see more of them when they open a new screen than one that prefers menus.
The style of the interaction may depend on the topic, location and device combination (for example, if Andrew is out of the house on his iPhone: he probably just wants a quick check or to nudge a setting; if Jane is in the house on the PC: she is about to set the monthly budget).

In addition, the user may be able to configure the interface to suit them by dragging and dropping items, right-clicking and selecting options, etc. The design may also comprise an aging process, so that recent and frequent topics are closer to the top of some a stack and infrequent requests from some time ago drop off the bottom.

Contextual help, searchable help, “how-to” type of pages etc. will all be relevant to different users in different situations. Clicking through links should lead to appropriate pages and there may be a (default) option to pin a link to the point where the help was requested.

There are many different styles of interface and many good elements that have emerged from those styles. The aim is for the power of the HEMS to be accessible flexibly, adaptably and consistently. When a user does something on a new page, the result should be what would be expected from similar experiences on other pages.

In addition to the preferences of the user being reflected in the adaptation of their current HEMS to their use, their persona may comprise details of their preferred interaction styles, so that another HEMS can start from an understanding of them, which can be translated into the new system. The design elements of the interface may be different (e.g. for different HEMS manufacturers), but the preferences for tables of numbers and quick nudges to the settings away from home on a mobile device could be shared.

### Example 1: Chris and Joan have Visitors

In a first example of operation of a HEMS in accordance with an embodiment of the invention, we consider a household with the following user profiles:
Chris (68) and Joan (69) are married with two children who have now left the home.
Joan tends to react to her environment for heat and hot water and also feels the cold due to a slight medical condition.
Chris likes to keep his eye on the budget, but prioritises his wife's needs.
Chris and Joan are retired, and have a small private pension to top up their income.
They live in a 4 bedroom 1960's built detached house. They have an old 1980's gas boiler with a water tank and 2 heating zones (“Living Rooms” and “Bedrooms”). The house has had some insulation work done in the past (loft insulation in the 1990's), but nothing since then.
Their adult children and families visit from time to time, and Joan likes to make sure they are always comfortable.

In the present example, Joan is excited that her elder daughter is visiting with their three year old grand-daughter. She knows that Chris is worried about the heating bills and that heating up their bedrooms for a few days will cost extra money, as well as extra baths etc.

Joan hardly ever uses the HEMS. Normally, she tells Chris what she wants and leaves it to him. While he is out, she logs onto her account and tries to find the budgeting module. The HEMS recognises this as unusual behaviour, since her normal contact is to nudge up the settings in a few of the rooms for an hour or two, a few times a week. She has never changed the programme settings.

Chris, on the other hand, set all the schedules up and has not changed them for months. However, he sits down every month and looks at his energy usage and costs. He also nudges the temporary settings from time-to-time, normally when Joan is in, and normally in the same rooms at similar times. However, he also increases the temperature in one of the other rooms that is normally not very much heated, whether Joan is in or not, and this tends to coincide with an unrecognised light being on and an unrecognised electrical device being used. In fact he is carrying out a hobby in the spare room.

The HEMS recognises that Chris is in control of the heating system and the budgeting and that the current interaction with Joan is high risk because she is acting outside her experience in an area that normally is only entered by Chris. It also recognises that actual day-to-day temperature choices are hers.

When Joan enters the budgeting pages, the HEMS tries to find out what she is trying to achieve by offering her some options, based on what options other HEMS users that fit her profile have used at this point. Joan selects the option to cost alternate schedules. The HEMS asks Joan if she has visitors and she says yes. The HEMS switches her to the visitor pages where she identifies one adult and one small child and which rooms they will be using and when they will be staying. It offers her a schedule and adds the estimated cost to the report, since Joan entered through the budget pages. Joan fine tunes the temperature schedules once the HEMS has offered her a choice of scheduling interfaces and she liked the one where you drag lines on a chart.

Joan is surprised to see that the extra heating will only cost £2:50 for the entire visit and how little effect the fine-tuning has. The HEMS offers a menu of other services that the visitors may need and Joan adds some baths, clothes washing and drying and subtracts cooking a meal, since her daughter is taking them out. Joan is surprised that the water and energy for these activities costs a little bit of money and that not doing a roast saves some of the money.

The HEMS asks if Joan wants to implement the changes or store them and she selects to store them. Now she is ready to discuss the arrangements for the visit with Chris to persuade him that they can afford to look after her family properly. Her confidence in the HEMS is increased and she starts to look at other costs and schedules. Chris is pleased to discover that she chooses to drop some temperature settings, now that she realises what they cost.

### Example 2: Christine Worries about Damp in a Bedroom

In a second example of operation of a HEMS in accordance with an embodiment of the invention, we consider a household with the following user profiles:
Alan (38) and Christine (36) are married with two children, Jack (8) and newborn Lucy (2 months).
Christine likes to plan her heating schedule, while Alan tends to react more to his environment at a specific time and place.
Alan is employed full time, as is Christine who is currently on maternity leave. Between them they have a good family income (above average) although their budget is under increasing pressure with the demands of a growing family and work that needs doing on the house (although the children are their priority). They both hate waste.
They live in a 4 bedroom 1970's built semi-detached home with a modern condensing gas boiler with water tank, and 2 heating zones (“Living Rooms” and “Bedrooms”). Some of the house has been modernized, but not all, and there is a damp problem in one of the bedrooms.
Christine also tries to help her elderly mother (Carol, 72) who lives alone but who visits the family often.

Christine is worried about a damp problem in the spare bedroom and is interested in whether the family income could be stretched a bit further, thinking ahead to when Lucy has her own room and Carol comes to stay the night as a babysitter.

The HEMS knows that Christine is the lead user and that she often sits down, requests information and sets schedules when Alan is clearly out at work.

Today Christine asks about humidity in a first spare bedroom and for this data to be charted over the last two months (December and January). The HEMS asks her if she is worried about damp and mould and she answers yes. It presents the estimated humidity data that she requested and also asks if the windows have condensation on the inside (because this seems highly likely, given the temperature, humidity, and estimated internal temperature of the panes). Christine answers yes and that the windows have mouldy frames. The HEMS offers two options:
1) To replace the windows with a different specification that will avoid the condensation and reduce the heat loss, thus allowing the room to be kept at a lower temperature and saving an estimated £25 per year on the heating bill; or
2) To increase the room temperature to try and eliminate condensation which would have added £35 to the heating bills over the last year and which might not work.

Christine then asks how much the heating bills would increase if the second spare bedroom was used as Lucy's room and what the heating schedule should be. The HEMS shows a chart for the last month of the actual room temperatures and its recommended heating schedule. It estimates the increased cost would have been £75 over the last twelve months, broken down by month. Christine notices that most of the cost is in the months of December, January and February and asks for a range based on warm and cold years. The HEMS adds these to the chart.

Christine then asks what the costs would be to use the second spare room as Lucy's room in both options outlined above. In option (1) the saving would be eliminated and the extra costs would be £20 per year. In option (2) the extra costs would be £60 over baseline (£25 more than humidity elimination). The HEMS checks that the additional water output of a small child will not breach the condensation barrier.

Christine asks the HEMS to implement option (2) and decides to get Alan to get some estimates for replacing the windows in both bedrooms and then redecorating the first spare room as the baby's room afterwards. Over the next couple of weeks Christine notices that the higher heating level reduces condensation but does not completely eliminate it.

It will be clear from the above that embodiments of the present invention have a number of advantages over the prior art.

It will also be appreciated by persons skilled in the art that various modifications may be made to the above embodiments without departing from the scope of the present invention as defined by the claims. For example, features from one embodiment may be mixed and matched with features from other embodiments.

1. A method of controlling an environment management system within a building, comprising:
monitoring appliance usage within said building;
determining patterns of appliance usage that are characteristic of an occupant;
creating and storing a persona comprising the patterns of appliance usage;
identifying an expected pattern of appliance usage associated with the occupant based on a comparison of detected appliance usage with the occupant's stored persona; and
operating the environment management system to control the environment in the building, in accordance with the persona.

2. The method according to claim 1, wherein the management system uses the persona to predict future environment requirements and adapts to meet said requirements.

3. The method according to claim 1, wherein the persona further comprises one or more of: behavioural data, needs descriptions and interaction style.

4. The method according to claim 1, wherein the step of monitoring appliance usage within the building comprises measuring at least one property associated with a utility to determine utility usage and identifying a pattern of use of one or more appliances that is expected to give rise to such utility usage.

5. The method according to claim 1, wherein the method comprises comparing recent data with historical data and/or comparing data collected from a plurality of buildings.

6. The method according to claim 1, comprising the use of probabilities associated with the likelihood of a pattern of appliance usage occurring at a particular time or in a particular sequence with one or more other patterns of appliance usage.

7. The method according to claim 1, comprising firstly comparing a most probable pattern of appliance usage with data obtained from monitoring the appliance usage.

8. The method according to claim 1, wherein the step of monitoring appliance usage within the building comprises monitoring two or more utilities and measuring one or more characteristics relating to each of the utilities to provide an output signal representative thereof; monitoring for changes in the state of each of the output signals at predefined time intervals; and combining data from the output signals from each utility, to identify one or more patterns of appliance usage.

9. The method according to claim 1, wherein the step of determining patterns of appliance usage that are characteristic of an occupant comprises identifying an occupant of a building and determining a pattern of behaviour associated with that occupant.

10. The method according to claim 9, wherein the step of identifying an occupant comprises one or more of: user input; reference to an occupant schedule; recognition of a wireless signature associated with the occupant; or recognition of a particular pattern of behaviour associated with the occupant.

11. The method according to claim 1, comprising a learning period whereby the system monitors appliance usage for a period of time in order to identify recurring patterns of appliance usage.

12. The method according to claim 1, wherein the environment management system is operated to minimise dissatisfaction by the occupant.

13. The method according to claim 1, wherein the persona is related to a personality type.

14. The method according to claim 1, wherein the persona further comprises user data which is obtained by user input and/or information gained from user interactions with the system.

15. The method according to claim 1, wherein the step of operating the environment management system, in accordance with the persona, comprises one or more of: i) reviewing the occupant's preferences and scheduling/rescheduling a heating/hot water program to take such preferences into account; ii) adapting a user interface for the environment management system; and iii) comparing recent patterns of appliance usage with historic patterns of appliance usage to predict occupant needs over a period of time.

16. The method according to claim 15, wherein the preferences comprise scheduling criteria, budgeting criteria or room priorities.

17. The method according to claim 1, comprising a comparison of the patterns of appliance usage of the occupant with patterns of appliance usage determined for other occupants of the same or other buildings.

18. The method according to claim 1, further comprising: comparing personas; grouping those that have similar characteristics into clusters; and drawing inferences on likely behaviour of an occupant based on typical behaviour patterns of others within the same cluster.

19. The method according to claim 1, wherein, when two or more occupants are identified within a building, the system attempts to ascribe the patterns of appliance usage to individual occupants, either as their own actions or as a share of activities required to meet shared needs.

20. The method according to claim 1, wherein, when two or more occupants are identified within a building their individual personas are compared and the environment management system is controlled to minimise dissatisfaction by each occupant.

21. The method according to claim 1, wherein the environment management system comprises a user interface configured to adapt to a user's preferred style of interaction.

22. The method according to claim 21, wherein the user's preferred style of interaction is derived from the occupant's persona and/or learnt by the system through the occupant's interaction with local control systems.

23. The method according to claim 1, wherein the persona assigned to the occupant is portable and can be used by said occupant when in another building.

24. The method according to claim 1, wherein the identities of individuals assigned to a persona are protected.

25. The method according to claim 1 wherein identifying a pattern of appliance usage associated with the occupant comprises identifying when the occupant is out of the building and is next likely to return to the building.

26. An apparatus for operating an environment management system within a building, comprising:
apparatus for monitoring appliance usage within said building; and
a processing device configured to determine patterns of appliance usage that are characteristic of an occupant; to create and store a persona of the occupant comprising said patterns of appliance usage by the occupant; to identify an expected pattern of appliance usage associated with the occupant based on a comparison of detected appliance usage with the occupant's stored persona; and to operate the environment management system to control the environment in the building in accordance with the persona.

27. A building environment management system comprising:
apparatus for monitoring appliance usage within a building; and
a processing device configured to determine patterns of appliance usage that are characteristic of an occupant; to create and store a persona of the occupant comprising said patterns of appliance usage by the occupant; to identify an expected pattern of appliance usage associated with the occupant based on a comparison of detected appliance usage with the occupant's stored persona; and to operate the environment management system to control the environment in the building in accordance with the persona.
